(19) United States
(12) Patent Application Publication
(10) Pub. No.: US 2005/0160999 A1
(43) Pub. Date: Jul. 28, 2005

(54) Oyster culture installation

(76) Inventors: Andres Quinta Cortiñas, VALGA (ES); Eladio Diaz Arbones, Valga (ES)

Correspondence Address: BREINER & BREINER, 115 NORTH HENRY STREET, P. O. BOX 19290, ALEXANDRIA, VA, 22314, US

(21) Appl. No.: 10/520,161

(22) PCT Filed: Jun. 26, 2003
(86) PCT No.: PCT/ES03/00317

(30) Foreign Application Priority Data
Jul. 5, 2002 (ES) P200201585

(51) Int. Cl. A01K 61/00

(52) U.S. Cl. 119/208

(57) ABSTRACT

The improved shellfish farm is formed by a modular structure consisting of at least one first platform comprising a floating base which is equipped with ballast means and a second platform from which culture ropes are hung. The aforementioned platforms are stacked and separated at different levels by means of hollow columns, the height of said columns being essentially equal to the length of the culture ropes.

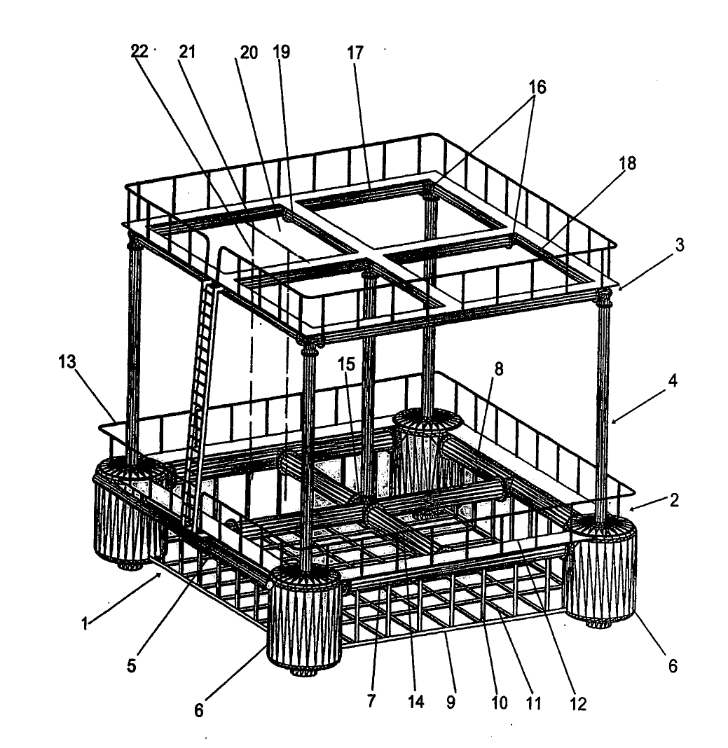

The invention relates to an improved shellfish farm which is formed by a modular floating structure which is also easy to submerge, offering substantial breeding capacity and being designed to provide easy extraction of the shellfish raised on the culture ropes.

The improved shellfish farm proposed in the present invention is specifically designed for the use in oyster farming in tropical mangroves, where the water from the tide extensively covers the ground leaving estuaries or swamp areas between the low islands formed. The shellfish farm in accordance to this invention can also be used in open sea or in lakes.

Oyster farming in mangroves is difficult due to the presence of parasites, which penetrate the developing oysters. Fortunately, the parasite is not capable of surviving out of the water longer than the oyster itself and can therefore be easily eliminated if the shellfish farm is maintained out of the water.

In the traditional shellfish breeding methods requiring shallow seabeds in quiet waters, matter is produced, which, in high concentrations, perturbs and offsets the balance of the surrounding ecosystem. This environmental pollution has a negative effect on the ecological balance by causing a decrease in the plankton flow and a drop of the feeding rate of the shellfish, with consequent reduction of the desired production of cultures.

Self-supporting fish breeding installations are already known, such as those proposed according to the Swedish patent SE 84-05854, or its Spanish equivalent ES 549082 by Götmalm, which discloses a device for breeding of fish or the like in open sea or a lake in a netted bag supported by a pontoon, the depth position of which is variable, at which a sinker having water as releasable ballast, is arranged at the lower end of the netted bag, which sinker and thereby the bottom of the netted bag is liftable to the water surface by blowing air into the tanks of the sinker.

Other self-supported installations are also constructed for breeding shellfish, such as that disclosed in the document ES 1043285U by Carceller, which describes a live well improved for growing mussels in open sea, comprising a rope or longline from which the breeding ropes are hanging and which is maintained in a horizontal position once extended and grounded by means of weights anchored on the sea floor, while subjected to the uplift force exerted by a plurality of buoys or floats to which it is attached in combination with a plurality of surface floats, said live well is provided with an improved support and beaconing facility.

These already existing installations, in particular of the type with self-supporting flotation buoys, have proven their open sea capabilities but have the drawback that the impact of the waves and the weight of the load during vertical movement can not only cause the detachment of the animals due to rupture of the supporting byssus, but can also result in exhausting or stressful situations for some breeding species. Furthermore, they are not appropriate for breeding shellfish in mangroves.

One of the aims of this invention is to enable the breeding of oysters in mangroves in such way that the penetrating parasite is eliminated, thus increasing with it the quantity of oysters farmed. A further aim is to improve the conditions for adapting to the swell so as to avoid the sudden rocking of the culture ropes, which cause the fatigue of the animals or their detachment due to rupture of the byssus. In addition, the device is designed in such way that the farming or working of the cultures can take place with limited manual intervention.

It is the intention to achieve the above-mentioned aims with the improved shellfish farm proposed in the present invention, which relates to a modular structure consisting of at least one first platform comprising a floating base which is equipped with ballast means and a second platform from which culture ropes are hung. The aforementioned platforms are stacked and separated at different levels by means of hollow columns, the height of said columns being essentially equal to the length of the culture ropes. A ladder is available between both platforms to facilitate the tasks related to the farming of the cultures.

The first platform is supported by a flotation base which itself is formed by a plurality of immersion tanks which are interconnected by girders and hollow cross members. The abovementioned first platform comprises lateral walls and a base, both allowing the free passing of water through them and which can be covered with a net or the like to form a farming area for other marine species and which additionally comprises foot bridges which are mounted on the platform on an adequate level and which are protected with handrails to enable the passing of people.

The second platform is constituted of a framework of girders and cross members and supported by the forementioned hollow columns which, for example, vertically emerge from the submersion tanks and onto which a plurality of platforms is laid, said platforms being protected with handrails and which provide openings to regularly arrange the supports for the culture ropes.

The immersion tanks are equipped with a water ballast which can be removed by blowing air in a manner that the farm can advantageously be lifted to the desired level or to the water surface by introducing air into the immersion tank reservoirs, which is commonly the case when the farm is located in a depth suitable for farming or during laboring or extraction of produce occurs. It is evident that the oyster bearing ropes will be exposed to the air when the farm is located on the water surface and that the abidance outside the water will cause the extermination of the parasites.

In a preferred embodiment, this invention comprises a modular structure consisting of at least one first and one second platform, both of which are stacked and separated at different levels by means of hollow columns. The culturing ropes for the oysters are advantageously located between the aforementioned platforms in such manner that, for example, said ropes hang from substantially horizontal supports which are fitted between the openings formed between the foot bridges mounted on the first platform.

Preferably, the first platform is constituted of a plurality of immersion tanks, which, in this example, are distributed along the corners of the regular polygon, which is created by said platform. The abovementioned immersion tanks are joined to each other by means of girders and substantially horizontally positioned hollow cross members, all of which in combination constitute a flotation base. Said flotation base comprises lateral walls and a base, both allowing the free passage of water through them and which can be covered with a net or the like to form a farming area for other marine species and which additionally comprises a number of foot bridges conveniently distributed on the platform and which are protected with handrails to enable the passing of people.

Each of said immersion tanks fitted on the first platform is joined to at least each of the corners of the second platform by means of one vertically upright standing hollow column emerging from it.

The second platform is preferably constituted of a framework of girders and cross members which themselves are supported by the abovementioned hollow columns vertically emerging from the immersion tanks and which, in this example, is further supported in its centre by a suitable column emerging from the centre of the first platform. The oyster culturing ropes are advantageously hung from the described framework on the second platform and on the girders and cross members a number of foot bridges are mounted which themselves are protected with handrails.

To facilitate comprehension of the ideas presented here, a preferred embodiment of the invention is given below, with reference to the accompanying illustrative drawings, which shall not limit by their selection or graphical representation the advantages and particular characteristics of this application.

The sole figure shown in the illustration sheet shows a perspective frontal top view of an improved shellfish farm in accordance with this invention, which is represented schematically so as to provide a better view.

The figure illustrates a modular structure of parallelopipedic geometry (1) which in turn defines the shape of the shellfish farm and which comprises a first platform (2) and a second platform (3), both of which are stacked and separated at different levels by means of hollow columns (4).

Said first platform (2) comprises a flotation base (5), which is rectangular in this exemplary configuration and shows a number of immersion tanks (6) at its corners which are joined to each other by means of girders (7) and cross members (8). Furthermore, the flotation base (5) incorporates an enclosed farming area (9) formed by lateral walls (10) and a base (11), both allowing the free flow of water and being covered by a net (not shown). In the embodiment shown, foot-bridges (12) protected with handrails (13) to enable the passing of people are mounted at least on the girders (7) and on the cross members (8), both of which constitute the lateral supports for the flotation base (5). It is easy to see that the foot-bridges can also be mounted on the hollow tubes (14) connecting the lateral parts of the flotation base (1) with a hollow knot (15) which in turn is positioned centrally to said flotation base.

Aforementioned second platform (3), shown as rectangular shaped in this example, is equally provided with hollow knots (16) mounted on its corners and centre in such way that the locations of said knots corresponds with the relative positions of the immersion tanks (6) and that of the hollow knot (15) on the first platform (2). The knots (16) provide a means of joining the ends of the girders (17), cross members (18) and those of the hollow columns (4), all of which are confluent to said knots, while at the same time they provide a way to centrally join the meeting ends of the hollow tubes (19). The embodiment shown illustrates how foot-bridges (12) protected with hand rails (13) to enable the passing of people are mounted on the girders (17), the cross members (18) and the hollow tubes (19) connecting the lateral parts of the platform (2) with the hollow knot (16) which is positioned centrally to the latter. It is easy to see that the hollow modular elements that constitute the structure can include filling materials and the like.

Openings (20) are advantageously placed between the foot-bridges (12) on the platform (3), said openings providing a means to place the supports (21) for the culturing ropes (22). With the aim of providing a better view of the figure, the supporting elements (21), which are here restricted to one of the openings, are represented with a dash-dot line and, similarly, the culture ropes are represented with a dashed line.

1-4. (canceled)

5. A shellfish farm for farming in mangroves of oysters and other marine species comprising a modular floating structure which is submersible and includes at least one first platform comprising a floating base equipped with ballast means and a second platform from which culture ropes hang, said at least one first platform and said second platform being stacked and separated at different levels by hollow columns, said hollow columns having a height which is essentially equal to length of the culture ropes.

6. The shellfish farm in accordance with claim 5, wherein said at least one first platform is supported by a flotation base formed by a plurality of immersion tanks which are interconnected by girders and hollow cross members.

7. The shellfish farm in accordance with claim 5, wherein said at least one first platform comprises lateral walls and a base, said walls and said base allowing free passage of water therethrough to provide a farming area for marine species, and which further comprises foot bridges mounted on the first platform on a level to allow passage by a person.

8. The shellfish farm in accordance with claim 5, wherein said second platform comprises a framework of girders and cross members, which in turn is supported by said hollow columns, said at least one first platform and said second platform including handrails providing openings to arrange supports for the culture ropes.
